(19) United States
(12) Patent Application Publication
(10) Pub. No.: US 2011/0202487 A1
(43) Pub. Date: Aug. 18, 2011

(54) STATISTICAL MODEL LEARNING DEVICE, STATISTICAL MODEL LEARNING METHOD, AND PROGRAM

(75) Inventor: Takafumi Koshinaka, Tokyo (JP)

(73) Assignee: NEC CORPORATION, Tokyo (JP)

(21) Appl. No.: 13/063,683

(22) PCT Filed: Jul. 22, 2009
(86) PCT No.: PCT/JP2009/003416

§ 371 Date: Mar. 11, 2011

(30) Foreign Application Priority Data
Oct. 21, 2008 (JP) 2008-270802

(51) Int. Cl. G06F 15/18

(52) U.S. Cl. 706/12

(57) ABSTRACT

A statistical model learning device is provided to efficiently select data effective in improving the quality of statistical models. A data classification means 601 refers to structural information 611 generally possessed by a data which is a learning object, and extracts a plurality of subsets 613 from the training data 612. A statistical model learning means 602 utilizes the plurality of subsets 613 to create statistical models 614 respectively. A data recognition means 603 utilizes the respective statistical models 614 to recognize other data 615 different from the training data 612 and acquires each recognition result 616. An information amount calculation means 604 calculates information amounts of the other data 615 from a degree of discrepancy among the statistical models of the recognition results. A data selection means 605 selects the data with a large information amount and adds the same to the training data 612.

### TECHNICAL FIELD

The present invention generally relates to statistical model learning devices, statistical model learning methods, and programs for learning statistical models. In particular, the present invention relates to a statistical model learning device, a statistical model learning method and a program for learning statistical models which are able to efficiently estimate model parameters by selectively utilizing training data.

### BACKGROUND ART

Conventionally, this kind of statistical model learning device has been provided for the use of creating a referential statistical model when a pattern recognition device classifies an input pattern into a category. Generally, in order to create a high-quality statistical model, there is a known problem that it is necessary to have a large amount of labeled data, that is, data attached with a correct answer label of the classification category, and to bear personnel costs and the like for attaching the labels. In order to deal with such a problem, especially, this kind of statistical model learning device has been utilized to automatically detect the data with a large amount of information, that is, the data with labeling information which is not self-evident but effective in improving the quality of the statistical model, so as to efficiently create labeled data.

Nonpatent Document 1 and Nonpatent Document 2 designated hereinafter disclose an example of a statistical model learning device related to the present invention. As shown in FIG. 5, the statistical model learning device related to the present invention is composed of a labeled data storage means 501, a statistical model learning means 502, a statistical model storage means 503, an unlabeled data storage means 504, a data recognition means 505, a reliability calculation means 506, and a data selection means 507.

The statistical model learning device related to the present invention has such a configuration as described hereinabove and operates in the following manner.

That is, the statistical model learning means 502 utilizes labeled data stored in the labeled data storage means 501 and limited in amount at first to create a statistical model and store the same in the statistical model storage means 503. The data recognition means 505 refers to the statistical model stored in the statistical model storage means 503, recognizes each data stored in the unlabeled data storage means 504, and calculates a recognition result. The reliability calculation means 506 receives the recognition result outputted by the data recognition means 505, and calculates a reliability which is a measure of assurance of the result. The data selection means 507 selects all of the data with a value of the reliability calculated by the reliability calculation means 506 being lower than a predetermined threshold value, shows the same to the workers and the like via a display, a speaker, and the like, accepts inputs of correct labels, and stores the data in the labeled data storage means 501 as new labeled data.

By repeating the above operation a necessary number of times, the labeled data stored in the labeled data storage means 501 is increased in amount, and a high-quality statistical model is stored in the statistical model storage means 503.
[Nonpatent Document 1] G. Riccardi & D. Hakkani-Tur, “Active and unsupervised learning for automatic speech recognition”, Proc. of EUROSPEECH 2003, September 2003.
[Nonpatent Document 2] Kato, Toda, Saruwatari, and Shikano, “Transcription cost reduction for acoustic model construction by speech data selection based on acoustic likelihoods”, Research Report by Information Processing Society of Japan, 2005-SLP-59 (45), pp. 229-234, Dec. 22, 2005.

### SUMMARY

The aforementioned technological problem related to the present invention resides in a low precision of efficiently selecting the data effective in improving the quality of the statistical model from the unlabeled data.

Like the above-mentioned technology related to the present invention, in the case of selecting unlabeled data based on the reliability, at an early stage with a considerable difference between the statistical model acquired at the present time and an ideal statistical model, it is not necessarily possible to select the effective data. The reason is that although selecting the data with a value of the reliability being lower than a predetermined threshold value may function in selecting the data close to the category boundary defined by the statistical model, at an early stage with the statistical model of a low quality, the category boundary is also not accurate, and thereby the data in the vicinity of the category boundary may not necessarily be effective in improving the quality of the statistical model. When such a data selection is carried out, the quality of the statistical model increases slowly and, as a result, a large amount of data is selected, thereby demanding a large amount of cost for attaching the labels.

Accordingly, an exemplary object of the present invention is to provide a statistical model learning device, a statistical model learning method and a program for learning statistical models which have solved the above problem of a low precision of efficiently selecting the data effective in improving the quality of the statistical model from the unlabeled data.

The present invention provides a statistical model learning device including: a data classification means for referring to structural information generally possessed by a data which is a learning object, and extracting a plurality of subsets from the training data; a statistical model learning means for learning the subsets and creating statistical models respectively; a data recognition means for utilizing the respective statistical models to recognize other data different from the training data and acquire recognition results; an information amount calculation means for calculating information amounts of the other data from a degree of discrepancy of the recognition results acquired from the respective statistical models; and a data selection means for selecting the data with a large information amount from the other data, and adding the same to the training data.

An exemplary effect of the present invention is that it is possible to provide a statistical model learning device, a statistical model learning method and a program for learning statistical models which are capable of efficiently selecting the data effective in improving the quality of the statistical model from a preliminary data to create a high-quality training data and, furthermore, a high-quality statistical model at a low cost.

### BRIEF DESCRIPTION OF DRAWINGS

FIG. 1 is a block diagram showing a configuration of a first exemplary embodiment of the present invention;

FIG. 2 is a block diagram showing a configuration of an example of an apparatus for creating T typical speakers' Gaussian mixture models;

FIG. 3 is a flowchart showing an operation of the first exemplary embodiment of the present invention;

FIG. 4 is a block diagram showing a configuration of a second exemplary embodiment of the present invention;

FIG. 5 is a block diagram showing a configuration of an example of a statistical model learning device related to the present invention; and

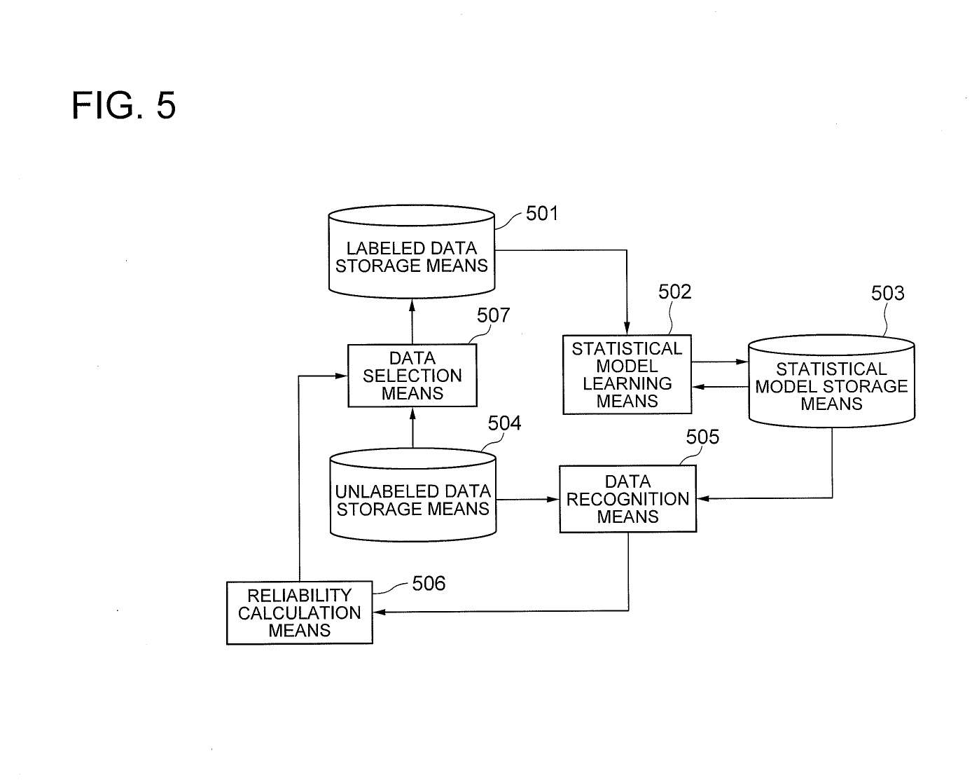

FIG. 6 is a block diagram showing a configuration of a third exemplary embodiment of the present invention.

### EXEMPLARY EMBODIMENTS

Next, exemplary embodiments of the present invention will be described in detail in reference to the accompanying drawings.

### A First Exemplary Embodiment

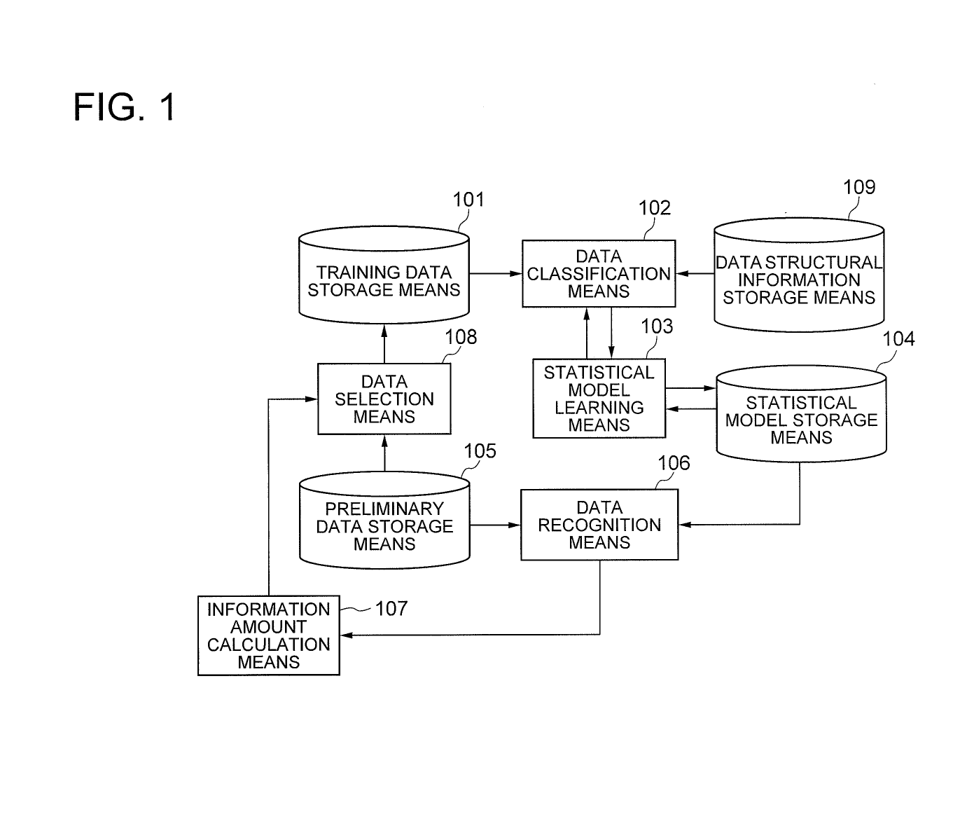

Referring to FIG. 1, a first exemplary embodiment of the present invention includes a training data storage means 101, a data classification means 102, a statistical model learning means 103, a statistical model storage means 104, a preliminary data storage means 105, a data recognition means 106, an information amount calculation means 107, a data selection means 108 and a data structural information storage means 109, and operates to impartially create T statistical models in a generally extremely high-dimensional statistical model space based on the information with respect to data structures stored in the data structural information storage means 109, and calculate the information amount possessed by each preliminary data based on the variety, that is, the degree of discrepancy of the recognition results acquired from the T statistical models. By adopting such a configuration, utilizing the T statistical models disposed in an area with a higher possibility in consideration of the real-world data structures, and selecting the data effective in improving the quality of the statistical model, it is possible to achieve the exemplary object of the present invention. Hereinbelow, explanations will be made with respect to the details of the components.

The training data storage means 101 stores training data necessary for learning the statistical models. Generally, a training data is attached with a label indicating the category to which the data belongs, and such a data will be referred to as a labeled data. A labeled data may have any particular contents, which are determined by an assumed pattern recognition device. For example, in the case of assuming a character recognition device as the pattern recognition device, the data is a character image, and the character code and the like corresponding to the character image are equivalent to the label. In the case of assuming a face recognition device as the pattern device, the data and the label are respectively a face image of a person and some ID for identifying the person. In the case of assuming a sound recognition device as the pattern recognition device, the data is sound signals divided by a unit according to each speech or the like, and the label is a word ID, a phonetic symbol string or the like indicating the contents of the speech.

The preliminary data storage means 105 stores data collected aside from the data stored in the training data storage means 101. These data are, similar to the data stored in the training data storage means 101, character images, face images, common object images, sound signals and the like which are determined according to the assumed pattern recognition device, but may not be necessarily attached with labels.

The data structural information storage means 109 stores the information with respect to the structures generally possessed by the data stored in the training data storage means 101 and the preliminary data storage means 105. For example, in the case of assuming a sound recognition device to deal with sound signals as the data, there is structural information generally possessed by sound signals such as approximately what kind of speakers may exist, what kind of noises may be superimposed, and the like.

The same is true on the data other than sound signals. For example, the following correspond to the structural information: the illumination condition, object direction (posture) and the like for face images and common object images, and the variation of writers or writing materials and the like for character images.

The data classification means 102 refers to the structural information stored in the data structural information storage means 109 to classify the data stored in the training data storage means 101 into a predetermined number of such as T subsets S₁, . . . , and S_{T}. The subsets may be the training data divided without overlapping, or may also be configured to have a common portion each other.

Further detailed explanations will be made hereinafter with respect to the operations of the data classification means 102 and the data structural information storage means 109.

The statistical model learning means 103 sequentially receives the T subsets S₁, . . . , and S_{T} from the data classification means 102 to carry out learning, estimates a parameter defining the statistical model, and sequentially stores the statistical models acquired as the results in the statistical model storage means 104. As a result, after learning T times, T statistical models θ₁, . . . , and θ_{T} are stored in the statistical model storage means 104. Therein, θᵢ is a set of the parameters uniquely designating the statistical model and, for example, in the case of a hidden Markov model frequently utilized in acoustic models for sound recognition, θᵢ includes a set of parameters such as the average, dispersion, mixing coefficient and the like of the state transition probability and Gaussian mixture distribution.

The data recognition means 106 respectively refers to the T statistical models stored in the statistical model storage means 104 to recognize the data stored in the preliminary data storage means 105 and acquire T recognition results according to each data.

The information amount calculation means 107 compares the T recognition results outputted by the data recognition means 106 according to each data with each other, and calculates the information amount of each data. Herein, the information amount is a calculated amount according to each data, and regarded as the variety, that is, the degree of discrepancy of the T recognition results. In other words, if the T different models have all produced the same recognition result, then the information amount of the data is low. On the contrary, if the recognition results produced from the T models are completely different, and thus T different recognition results are produced, then the information amount of the data is considered high.

Various methods are conceivable to quantitatively render such kind of information amount, and a few examples will be shown hereinbelow. One is a method for defining the difference r₂−r₁ as the information amount where r₁ is the greatest number of the acquired recognition results, and r₂ is the second greatest number of the acquired recognition results. For example, if the T recognition results are all the same, then r₂−r₁=−T, and thus the information amount becomes the lowest. On the other hand, if the T recognition results are all different, etc., then r₂−r₁=0, and thus the information amount becomes the highest. As another example, such a method is also conceivable as to render the degree of variation with an entropy such as the following formula 1 where fᵢ is the number of the recognition results i.

$$- {\sum }_{i} \frac{{f}_{i}}{T} log \frac{{f}_{i}}{T} ( {\sum }_{i} {f}_{i} = T ) \qquad [ Formula 1 ]$$

As still another example, the congruency and discrepancy of y₁, y₂, . . . , and y_{T} as the T recognition results with respect to the data may also be counted in an exhaustive manner such as the following formula 2 where δᵢⱼ is a Kronecker delta, that is, a binary variable which is 1 if i=j; otherwise it is 0.

$$- \frac{1}{T ( T - 1 )} {\sum }_{i \neq j} {δ}_{{y}_{i} {y}_{j}} \qquad [ Formula 2 ]$$

In the case of outputting the recognition results in the form of probability or a score based on probability, it is possible to consider still another example expanding the formula 2. That is, in the case of outputting the recognition results yε{1, 2, . . . , C} of the dadaₓ (where C is the total number of the categories) according to a statistical model θᵢ in probability distribution p (y|x, θᵢ), the information amount may be defined such as the following formula 3 based on the divergence of the probability distribution.

$$\frac{1}{T ( T - 1 )} {\sum }_{i \neq j} D [ p ( y \vert x , {θ}_{i} ) \vert \vert p ( y \vert x , {θ}_{j} ) ] \qquad [ Formula 3 ]$$

Therein, D is some measure for measuring the degree of divergence among the probability distribution such as KL divergence and the like.

Further, if the recognition result y is a data series in some continuous units, for example, word strings such as the recognition results of a large vocabulary continuous speech, then the above calculation may be carried out according to each word and the like by dividing the data series into words.

The data selection means 108 selects the data with a value of the information amount calculated by the information amount calculation means 107 being lower than a predetermined threshold value, or a predetermined number of data in ascending order of the information amount, shows those data to the workers and the like via the display, speaker or the like as necessary, accepts inputs of the correct labels, adds the data to the training data storage means 101, and deletes the data from the preliminary data storage means 105.

By repeating the above operation a predetermined number of times, the training data storage means 101 efficiently accumulates the data effective in improving the quality of the statistical model. At this stage, after finishing repeating the operation the predetermined number of times, the statistical model learning means 103 utilizes all of the training data stored in the training data storage means 101 to create one statistical model and output the same.

Next, further detailed explanations will be made with respect to the operations of the data classification means 102 and the data structural information storage means 109.

As described hereinbefore, the data structural information storage means 109 stores the information with respect to the structures generally possessed by the data stored in the training data storage means 101 and the preliminary data storage means 105.

For example, suppose that the data are sound signals, and the data structural information storage means 109 stores the structural information with respect to the speakers. In such a case, the structural information with respect to the speakers stored in the data structural information storage means 109 is T typical speakers' models. As the model type, a probability model is considered as preferable such as the publicly known Gaussian Mixture Model or GMM and the like. Therefore, although explanations will be made hereinbelow on the assumption of a GMM, any other models suitable for rendering the structural information may also be adopted and, still, it is possible to utilize a simple form such as further specialized probability models, for example, mere data points (mean vectors of GMM and the like).

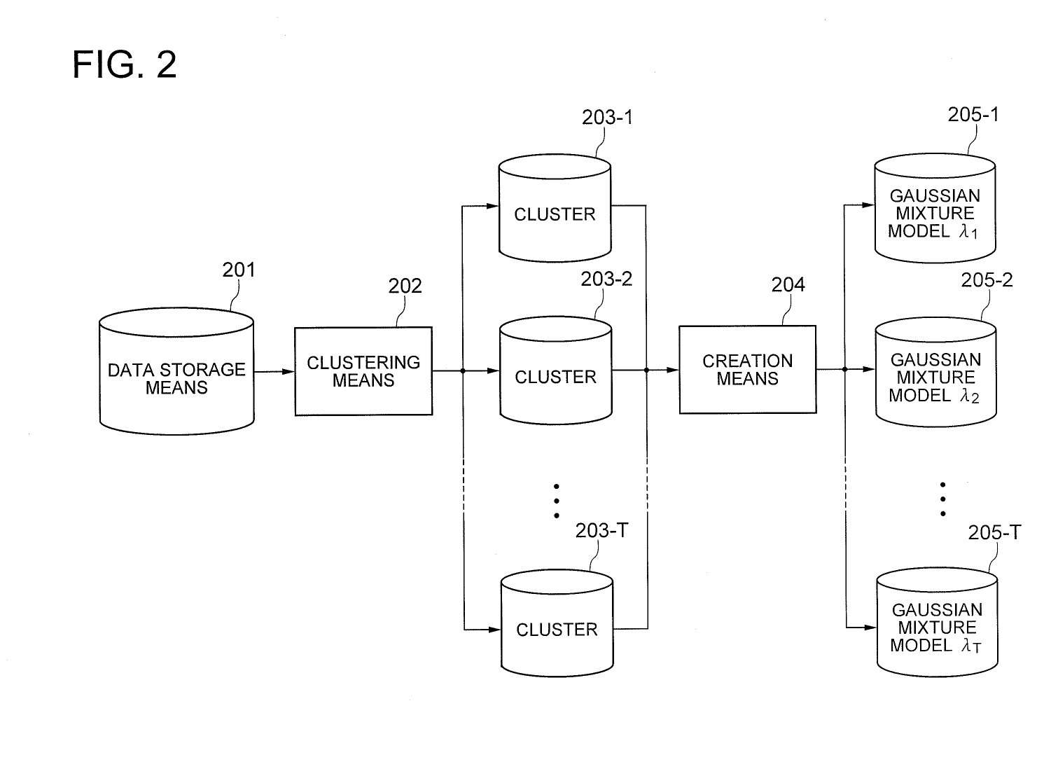

The T typical speakers' GMMs may be created in the following manner. That is, as shown in FIG. 2, sound signals including various speakers' speeches are collected into a data storage means 201, a clustering means 202 is utilized to classify those sound signals into T clusters (groups) 203-1 to 203-T by a publicly known clustering technique such as the K-means method and the like and, thereafter, a creation means 204 is utilized to create T GMMs λ₁, . . . , and λ_{T} 205-1 to 205-T by applying a publicly known maximum likelihood estimation method and the like to each of the clusters 203-1 to 203-T.

The same is true on the case of storing the structural information with respect to noise environments instead of speakers in the data structural information storage means 109. Further, in the case of storing the structural information combining speakers, noise environments, and any other factors, the above procedure may be performed by collecting sound signals including speeches of various speakers and noise environments. Further, it is self-evident that the same procedure is performable for data other than sound signals such as illumination condition and object direction (posture) for object images, and writers, writing materials, fonts and the like for character images.

The data classification means 102 refers to the T models with respect to the typical speakers, noise environments and the like rendered by the structural information stored in the data structural information storage means 109 to take out the T subsets S₁, . . . , and S_{T} from the data stored in the training data storage means 101. In particular, it calculates the degree of similarity (proximity) between each data stored in the training data storage means 101 and each GMM p (x|λᵢ) to assign each data to at least one of the T models.

A few specific methods for the assignment are conceivable, that is, methods for creating the subsets S₁, . . . , and S_{T}. As one example, each data is, such as the following formula 4, assigned to the proximal one of the T models (wherein arg max is an operator which takes the index with the maximum objective function). In this case, the T subsets are such that divides the data stored in the training data storage means 101 without overlapping each other.

$${S}_{i} = \{ x \vert i = {arg max}_{j} p ( x \vert {λ}_{j} ) \} \qquad [ Formula 4 ]$$

As another example, the degree of similarity may be calculated between each data stored in the training data storage means 101 and the i-th model to assign every data with a degree of similarity being greater than a predetermined threshold value α to the i-th model λᵢ such as the following formula 5. In this case, the T subsets may overlap each other.

Sᵢ={x|α<p(x|λᵢ)} [Formula 5]

As a similar example to the above one, such a method is also conceivable as to associate the data with the model λᵢ in descending order of the degree of similarity to the i-th model λᵢ until reaching a predetermined data amount (until reaching a predetermined number of items, until reaching a predetermined proportion of the original data amount, or the like).

In this manner, forming a subset of data in compliance with the structure possessed by the data has a meaning for improving the robustness of the statistical model against some kind of variable factors of the data. For example, in the case of utilizing T typical speakers' models λ₁, . . . , and λ_{T} with sound signals as the data to form T subsets S₁, . . . , and S_{T} and create T statistical models θ₁, . . . , and θ_{T} therefrom, it is possible to consider these statistical models as a statistical model group having impartially covered the variation of the statistical models due to speakers' variation. Thereby, it is conceivable that the information amount calculated on the basis of the statistical models θ₁, . . . , and θ_{T} renders whether or not the data has a high information amount with respect to the variation factor of speakers' variation. Therefore, it is conceivable that it is useful for acquiring robust statistical models against speakers' variation to preferentially attach labels to the data with a high information amount under such conditions and apply the same to learning statistical models.

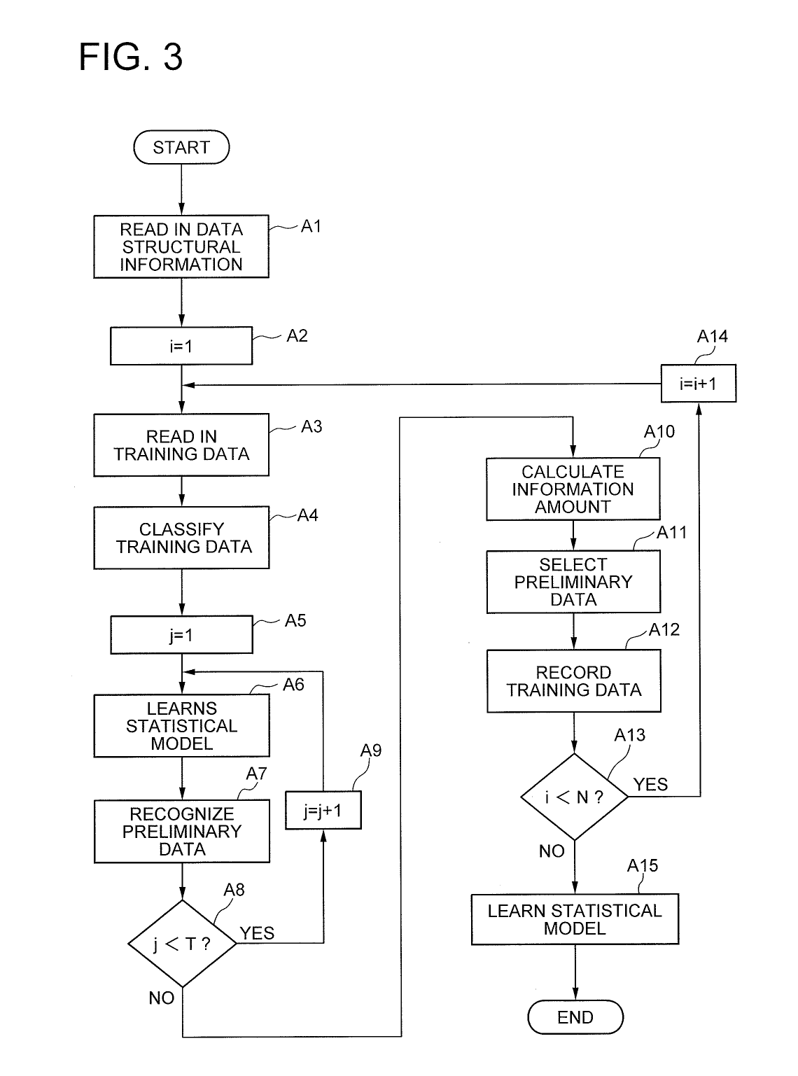

Next, explanations will be made in detail with respect to an overall operation of the first exemplary embodiment in reference to FIG. 1 and the flowchart of FIG. 3.

First, the data classification means 102 reads in the structural information of the data λ₁, . . . , and λ_{T} stored in the data structural information storage means 109 (the step A1 of FIG. 3), sets 1 to a counter i (the step A2), reads in the training data stored in the training data storage means 101 (the step A3), refers to the structural information, selects data from the training data, and forms T subsets S₁, . . . , and S_{T} by the method such as the formula 4 or 5 (the step A4). Next, the statistical model learning means 103 sets 1 to a counter j (the step A5), utilizes the j-th subset Sⱼ to carry out learning of the statistical model, and stores the acquired statistical model θⱼ in the statistical model storage means 104 (the step A6). Next, the data recognition means 106 recognizes each data stored in the preliminary data storage means 105 while referring to the j-th statistical model to acquire a recognition result (the step A7). If the counter j is smaller than T (the step A8), then the counter j is incremented (the step A9), and the process returns to the step A6; otherwise the process proceeds to the next step.

The information amount calculation means 107 utilizes the recognition result to calculate the information amount according to the formulas 1, 2, 3, and the like for each data stored in the preliminary data storage means 105 (the step A10). Next, the data selection means 108 selects the data with an information amount larger than a predetermined threshold value from the preliminary data storage means 105, shows the same to the workers and the like as necessary via the display, speaker and the like, accepts inputs of the correct labels (the step A11), records the data in the training data storage means 101, and deletes the same from the preliminary data storage means 105 as necessary (the step A12). Further, if the counter i has not reached a predetermined number N (the step A13), then the counter is incremented (the step A14), and the process returns to the step A3; otherwise the process proceeds to the next step.

Finally, the statistical model learning means 103 utilizes all the training data accumulated in the training data storage means 101 to create one statistical model and then ends the operation (the step A15).

Further, the counter i determines the end of the operation by a simple conditional determination that the operation is ended after being repeated the predetermined N times. However, the condition may also be substituted or combined with other conditions. For example, such a conditional determination may also be utilized as the operation is ended at the point of time that the training data stored in the training data storage means 101 has reached a predetermined amount, or at the point of time that no change has occurred on view of the update situation of the statistical models θ₁, . . . , and θ_{T}.

In the above manner, according to the first exemplary embodiment, the data classification means 102 selects data from the training data stored in the training data storage means 101 while referring to the structural information of the data stored in the data structural information storage means 109, that is, the models of typical speakers and noises for sound signals, the models of typical illumination condition and object posture (direction) for object images, to form T subsets. Further, the statistical model learning means 103 utilizes the T subsets to impartially dispose the T statistical models in compliance with the structural information of the data in the specific areas of the model space. Because of such configurations, it is possible to correctly calculate the information amount possessed by each preliminary data from the point of view of the structural information of the data, efficiently select the data effective in improving the quality of the statistical models, and create high-quality statistical models at a low cost.

Herein, a low cost means, first, that it is possible to hold down the cost for attaching labels to the preliminary data storage means 105. Next, it means that it is possible to minimize the necessary data amount stored in the training data storage means 101 to restrain the calculation amount for the learning. Especially, the latter is an effect which is obtainable even if labels have been attached to all the data stored in the preliminary data storage means 105.

### A Second Exemplary Embodiment

Next, explanations will be made in detail with respect to a second exemplary embodiment of the present invention in reference to the accompanying drawings.

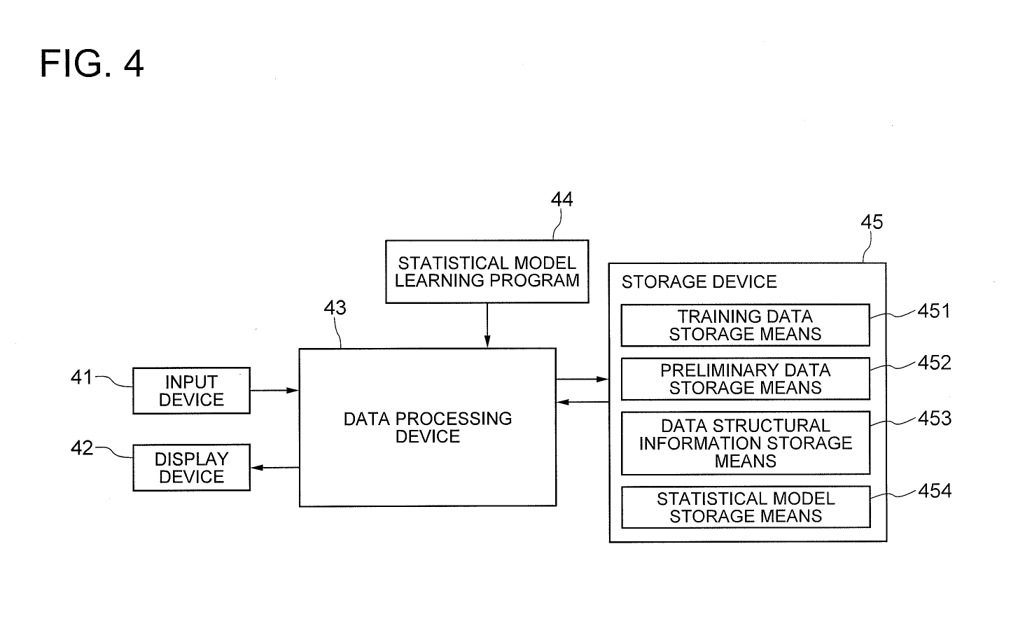

Referring to FIG. 4, the second exemplary embodiment of the present invention is configured with an input device 41, a display device 42, a data processing device 43, a statistical model learning program 44, and a storage device 45. Further, the storage device 45 has a training data storage means 451, a preliminary data storage means 452, a data structural information storage means 453, and a statistical model storage means 454.

The statistical model learning program 44 is read into the data processing device 43 to control the operation of the data processing device 43. The data processing device 43 carries out the following processes under the control of the statistical model learning program 44, that is, the same processes as those carried out by the data classification means 102, statistical model learning means 103, data recognition means 106, information amount calculation means 107 and data selection means 108 in accordance with the first exemplary embodiment.

First, through the input device 41, training data, preliminary data, and data structural information are stored in the training data storage means 451, the preliminary data storage means 452 and the data structural information storage means 453 in the storage device 45, respectively. In addition, it is possible to create the data structural information by a program causing a computer to carry out the process explained with FIG. 2.

Next, the data processing device 43 refers to the data structural information stored in the data structural information storage means 453, classifies the training data stored in the training data storage means 451, creates predetermined T subsets, learns the statistical model with respect to each subset, stores the acquired statistical models in the statistical model storage means 454, and utilizes the above statistical models to recognize the preliminary data stored in the preliminary data storage means 452 and acquire recognition results.

Further, the data processing device 43 utilizes the above recognition result acquired from each of the T statistical models to calculate the information amount of each preliminary data, select the data with a large information amount, and display the same on the display device 42 as necessary. Further, it accepts the labels inputted from the input device 41 with respect to the displayed data, stores the same along with the data in the training data storage means 451, and deletes the data from the preliminary data storage means 452 as necessary.

The data processing device 43 repeats the above process a predetermined number of times and, thereafter, utilizes all the data stored in the training data storage means 451 to learn the statistical models and store the acquired statistical models in the statistical model storage means 454.

### A Third Exemplary Embodiment

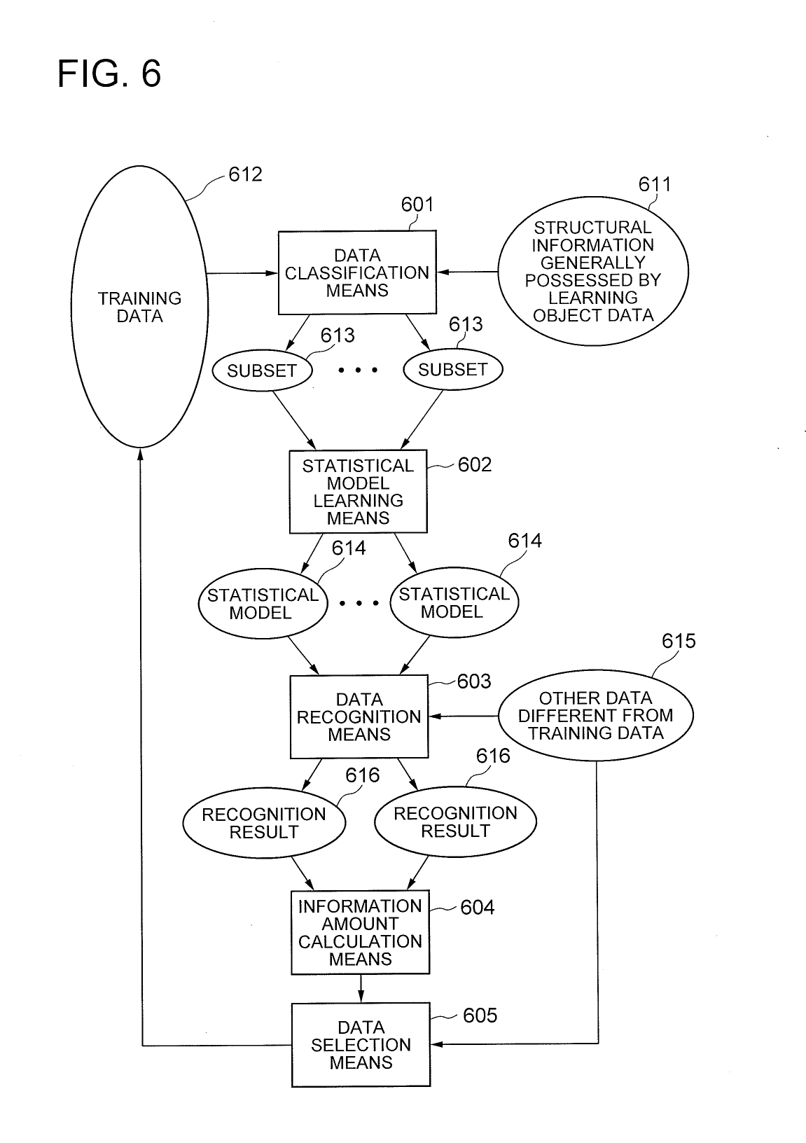

Next, explanations will be made with respect to a third exemplary embodiment of the present invention in reference to FIG. 6, which is a functional block diagram showing a configuration of a statistical model learning device in accordance with the third exemplary embodiment. Further, in the third exemplary embodiment, explanations will be made with respect to an outline of the aforementioned statistical model learning device.

As shown in FIG. 6, a statistical model learning device according to the third exemplary embodiment includes: a data classification means 601 for referring to structural information 611 generally possessed by a data which is a learning object, and extracting a plurality of subsets 613 from the training data 612; a statistical model learning means 602 for learning the subsets 613 and creating statistical models 614 respectively; a data recognition means 603 for utilizing the respective statistical models 614 to recognize other data 615 different from the training data 612 and acquire recognition results 616; an information amount calculation means 604 for calculating information amounts of the other data 615 from a degree of discrepancy of the recognition results 616 acquired from the respective statistical models 614; and a data selection means 605 for selecting the data with a large information amount from the other data 615, and adding the same to the training data 612.

Further, the statistical model learning device adopts such a configuration as a cycle is formed of extracting the subsets 613 by the data classification means 601, creating the statistical models by the statistical model learning means 602, acquiring the recognition results 616 by the data recognition means 603, calculating the information amounts by the information amount calculation means 604, and adding the other data 615 to the training data 612 by the data selection means 605; and the cycle is repeated until a predetermined condition is satisfied.

Further, the statistical model learning device adopts such a configuration as the statistical model learning means 602 creates one statistical model from the training data 612 after the predetermined condition is satisfied.

Further, the statistical model learning device adopts such a configuration as the structural information 611 generally possessed by the data which is the learning object is a model with respect to a variation factor of the data.

Further, the statistical model learning device adopts such a configuration as the model with respect to the variation factor of the data is a plurality of sets of the data subject to a typical variation.

Further, the statistical model learning device adopts such a configuration as the model with respect to the variation factor of the data is a probability model rendering a typical pattern of the data subject to variation.

Further, the statistical model learning device adopts such a configuration as the probability model is a Gaussian mixture model.

Further, the statistical model learning device adopts such a configuration as to further include: a clustering means for classifying a number of data under various influences due to the variation factor into a plurality of clusters; and a Gaussian mixture model creation means for creating the Gaussian mixture model according to each of the clusters.

Further, the statistical model learning device adopts such a configuration as the data is a sound signal; and the variation factor is at least one of a speaker and a noise environment.

Further, the statistical model learning device adopts such a configuration as the data is a character image; and the variation factor is at least one of a writer, a font and a writing material.

Further, the statistical model learning device adopts such a configuration as the data is an object image; and the variation factor is at least one of an illumination condition and an object posture.

Further, the statistical model learning device adopts such a configuration as the data classification means 601 extracts the plurality of subsets from a data attached with a label based on a degree of similarity between the probability model and the data attached with the label.

Further, another aspect of the present invention provides a statistical model learning method to be actualized through operation of the above statistical model learning device. The statistical model learning method adopts such a configuration as to include: referring to structural information generally possessed by a data which is a learning object, and extracting a plurality of subsets from the training data; learning the subsets and creating statistical models respectively; utilizing the respective statistical models to recognize other data different from the training data and acquire recognition results; calculating information amounts of the other data from a degree of discrepancy of the recognition results acquired from the respective statistical models; and selecting the data with a large information amount from the other data, and adding the same to the training data.

Further, the statistical model learning method adopts such a configuration as a cycle is formed of extracting the plurality of subsets, creating the statistical models, acquiring the recognition results of the other data, calculating the information amounts of the other data, and adding the other data to the training data; and the cycle is repeated until a predetermined condition is satisfied.

Further, the statistical model learning method adopts such a configuration as one statistical model is created from the training data after the predetermined condition is satisfied.

Further, the statistical model learning method adopts such a configuration as the structural information generally possessed by the data is a model with respect to a variation factor of the data.

Further, the statistical model learning method adopts such a configuration as the model with respect to the variation factor of the data is a plurality of sets of the data subject to a typical variation.

Further, the statistical model learning method adopts such a configuration as the model with respect to the variation factor of the data is a probability model rendering a typical pattern of the data subject to variation.

Further, the statistical model learning method adopts such a configuration as the probability model is a Gaussian mixture model.

Further, the statistical model learning method adopts such a configuration as to further include: classifying a number of data under various influences due to the variation factor into a plurality of clusters; and creating the Gaussian mixture model according to each of the clusters.

Further, the statistical model learning method adopts such a configuration as the data is a sound signal; and the variation factor is at least one of a speaker and a noise environment.

Further, the statistical model learning method adopts such a configuration as the data is a character image; and the variation factor is at least one of a writer, a font and a writing material.

Further, the statistical model learning method adopts such a configuration as the data is an object image; and the variation factor is at least one of an illumination condition and an object posture.

Further, the statistical model learning method adopts such a configuration as in extracting the plurality of subsets, the plurality of subsets are extracted from a data attached with a label based on a degree of similarity between the probability model and the data attached with the label.

Further, it is possible to install a computer program product into a computer to realize the above statistical model learning device and method. In particular, still another aspect of the present invention provides a computer program product which adopts such a configuration as to include computer executable instructions for causing a computer to carry out a processing operation including: a data classification process for referring to structural information generally possessed by a data which is a learning object, and extracting a plurality of subsets from the training data; a statistical model learning process for learning the subsets and creating statistical models respectively; a data recognition process for utilizing the respective statistical models to recognize other data different from the training data and acquire recognition results; an information amount calculation process for calculating information amounts of the other data from a degree of discrepancy of the recognition results acquired from the respective statistical models; and a data selection process for selecting the data with a large information amount from the other data, and adding the same to the training data.

Further, the computer program product adopts such a configuration as a cycle is formed of the data classification process, the statistical model learning process, the data recognition process, the information amount calculation process, and the data selection process; and the cycle is repeated until a predetermined condition is satisfied.

Further, the computer program product adopts such a configuration as the processing operation further includes a process for creating one statistical model from the training data after the predetermined condition is satisfied.

Further, the computer program product adopts such a configuration as the structural information generally possessed by the data is a model with respect to a variation factor of the data.

Further, the computer program product adopts such a configuration as the model with respect to the variation factor of the data is a plurality of sets of the data subject to a typical variation.

Further, the computer program product adopts such a configuration as the model with respect to the variation factor of the data is a probability model rendering a typical pattern of the data subject to variation.

Further, the computer program product adopts such a configuration as the probability model is a Gaussian mixture model.

Further, the computer program product adopts such a configuration as the processing operation further includes a process for classifying a number of data under various influences due to the variation factor into a plurality of clusters and creating the Gaussian mixture model according to each of the clusters.

Further, the computer program product adopts such a configuration as the data is a sound signal; and the variation factor is at least one of a speaker and a noise environment.

Further, the computer program product adopts such a configuration as the data is a character image; and the variation factor is at least one of a writer, a font and a writing material.

Further, the computer program product adopts such a configuration as the data is an object image; and the variation factor is at least one of an illumination condition and an object posture.

Further, the computer program product adopts such a configuration as in the data classification process, the plurality of subsets are extracted from a data attached with a label based on a degree of similarity between the probability model and the data attached with the label.

Even if the invention is the statistical model learning method or the computer program product having the above configurations, because it has the same function as the aforementioned statistical model learning device does, it is possible to achieve the exemplary object described hereinbefore.

Hereinabove, the present invention was described in reference to each of the exemplary embodiments. However, the present invention is not limited to the above exemplary embodiments. It is possible to apply various changes and modifications understandable by those skilled in the art to the configurations and details of the present invention without departing from the true spirit and scope of the present invention.

Further, the present invention claims priority from Japanese Patent Application No. 2008-270802, filed on Oct. 21, 2008 in Japan, the disclosure of which is incorporated herein by reference in its entirety.

### INDUSTRIAL APPLICABILITY

The present invention is applicable for various purposes. For example, it is possible to apply the present invention to statistical model learning devices for learning statistical models referenced by various pattern recognition devices including sound recognition devices, character recognition devices and individual biometric authentication devices, and by programs for pattern recognition, and to programs for realization of learning statistical models on a computer.

1. A statistical model learning device comprising:
a data classification unit for referring to structural information generally possessed by a data which is a learning object, and extracting a plurality of subsets from the training data;
a statistical model learning unit for learning the subsets and creating statistical models respectively;
a data recognition unit for utilizing the respective statistical models to recognize other data different from the training data and acquire recognition results;
an information amount calculation unit for calculating information amounts of the other data from a degree of discrepancy of the recognition results acquired from the respective statistical models; and
a data selection unit for selecting the data with a large information amount from the other data, and adding the same to the training data.

2. The statistical model learning device according to claim 1, wherein a cycle is formed of extracting the subsets by the data classification unit, creating the statistical models by the statistical model learning unit, acquiring the recognition results by the data recognition unit, calculating the information amounts by the information amount calculation unit, and adding the other data to the training data by the data selection unit; and the cycle is repeated until a predetermined condition is satisfied.

3. The statistical model learning device according to claim 2, wherein the statistical model learning unit creates one statistical model from the training data after the predetermined condition is satisfied.

4. The statistical model learning device according to claim 1, wherein the structural information generally possessed by the data is a model with respect to a variation factor of the data.

5. The statistical model learning device according to claim 4, wherein the model with respect to the variation factor of the data is a plurality of sets of the data subject to a typical variation.

6. The statistical model learning device according to claim 4, wherein the model with respect to the variation factor of the data is a probability model rendering a typical pattern of the data subject to variation.

7. The statistical model learning device according to claim 6, wherein the probability model is a Gaussian mixture model.

8. The statistical model learning device according to claim 7 further comprising: a clustering unit for classifying a number of data under various influences due to the variation factor into a plurality of clusters; and a Gaussian mixture model creation unit for creating the Gaussian mixture model according to each of the clusters.

9. The statistical model learning device according to claim 4, wherein the data is a sound signal; and the variation factor is at least one of a speaker and a noise environment.

10. The statistical model learning device according to claim 4, wherein the data is a character image; and the variation factor is at least one of a writer, a font and a writing material.

11. The statistical model learning device according to claim 4, wherein the data is an object image; and the variation factor is at least one of an illumination condition and an object posture.

12. The statistical model learning device according to claim 6, wherein the data classification unit extracts the plurality of subsets from a data attached with a label based on a degree of similarity between the probability model and the data attached with the label.

13. A statistical model learning method comprising:
referring to structural information generally possessed by a data which is a learning object, and extracting a plurality of subsets from the training data;
learning the subsets and creating statistical models respectively;
utilizing the respective statistical models to recognize other data different from the training data and acquire recognition results;
calculating information amounts of the other data from a degree of discrepancy of the recognition results acquired from the respective statistical models; and
selecting the data with a large information amount from the other data, and adding the same to the training data.

14. The statistical model learning method according to claim 13, wherein a cycle is formed of extracting the plurality of subsets, creating the statistical models, acquiring the recognition results of the other data, calculating the information amounts of the other data, and adding the other data to the training data; and the cycle is repeated until a predetermined condition is satisfied.

15. The statistical model learning method according to claim 14, wherein one statistical model is created from the training data after the predetermined condition is satisfied.

16. The statistical model learning method according to claim 13, wherein the structural information generally possessed by the data is a model with respect to a variation factor of the data.

17. The statistical model learning method according to claim 16, wherein the model with respect to the variation factor of the data is a plurality of sets of the data subject to a typical variation.

18. The statistical model learning method according to claim 16, wherein the model with respect to the variation factor of the data is a probability model rendering a typical pattern of the data subject to variation.

19. The statistical model learning method according to claim 18, wherein the probability model is a Gaussian mixture model.

20. The statistical model learning method according to claim 19 further comprising: classifying a number of data under various influences due to the variation factor into a plurality of clusters; and creating the Gaussian mixture model according to each of the clusters.

21. The statistical model learning method according to claim 16, wherein the data is a sound signal; and the variation factor is at least one of a speaker and a noise environment.

22. The statistical model learning method according to claim 16, wherein the data is a character image; and the variation factor is at least one of a writer, a font and a writing material.

23. The statistical model learning method according to claim 16, wherein the data is an object image; and the variation factor is at least one of an illumination condition and an object posture.

24. The statistical model learning method according to claim 18, wherein in extracting the plurality of subsets, the plurality of subsets are extracted from a data attached with a label based on a degree of similarity between the probability model and the data attached with the label.

25. A computer-readable medium storing a program comprising computer executable instructions for causing a computer to carry out a processing operation comprising:
a data classification process for referring to structural information generally possessed by a data which is a learning object, and extracting a plurality of subsets from the training data;
a statistical model learning process for learning the subsets and creating statistical models respectively;
a data recognition process for utilizing the respective statistical models to recognize other data different from the training data and acquire recognition results;
an information amount calculation process for calculating information amounts of the other data from a degree of discrepancy of the recognition results acquired from the respective statistical models; and
a data selection process for selecting the data with a large information amount from the other data, and adding the same to the training data.

26. The computer-readable medium storing the program according to claim 25, wherein a cycle is formed of the data classification process, the statistical model learning process, the data recognition process, the information amount calculation process, and the data selection process; and the cycle is repeated until a predetermined condition is satisfied.

27. The computer-readable medium storing the program according to claim 26, wherein the processing operation further comprises a process for creating one statistical model from the training data after the predetermined condition is satisfied.

28. The computer-readable medium storing the program according to claim 25, wherein the structural information generally possessed by the data is a model with respect to a variation factor of the data.

29. The computer-readable medium storing the program according to claim 28, wherein the model with respect to the variation factor of the data is a plurality of sets of the data subject to a typical variation.

30. The computer-readable medium storing the program according to claim 28, wherein the model with respect to the variation factor of the data is a probability model rendering a typical pattern of the data subject to variation.

31. The computer-readable medium storing the program according to claim 30, wherein the probability model is a Gaussian mixture model.

32. The computer-readable medium storing the program according to claim 31, wherein the processing operation further comprises a process for classifying a number of data under various influences due to the variation factor into a plurality of clusters and creating the Gaussian mixture model according to each of the clusters.

33. The computer-readable medium storing the program according to claim 28, wherein the data is a sound signal; and the variation factor is at least one of a speaker and a noise environment.

34. The computer-readable medium storing the program according to claim 28, wherein the data is a character image; and the variation factor is at least one of a writer, a font and a writing material.

35. The computer-readable medium storing the program according to claim 28, wherein the data is an object image; and the variation factor is at least one of an illumination condition and an object posture.

36. The computer-readable medium storing the program according to claim 30, wherein in the data classification process, the plurality of subsets are extracted from a data attached with a label based on a degree of similarity between the probability model and the data attached with the label.

37. The statistical model learning device according to claim 2, wherein the predetermined condition is determined by any one of or any combination of a plurality of the following: a repetition number of the cycle, an amount of the training data, and an update situation of the statistical model.
